(19) United States
(12) Patent Application Publication
(10) Pub. No.: US 2025/0037526 A1
(43) Pub. Date: Jan. 30, 2025

(54) METHOD FOR CONTROLLING ACCESS TO AN AREA TO BE SECURED, AND ASSOCIATED INITIALISATION METHOD

(71) Applicant: AKIDAIA, Nice (FR)

(72) Inventors: Ouajdi BABAY ROUIS, Cagnes-sur-Mer (FR); Gael LEDEDANTEC, Nice (FR)

(21) Appl. No.: 18/716,811

(22) PCT Filed: Nov. 30, 2022
(86) PCT No.: PCT/EP2022/083769

§ 371 Date: Jun. 5, 2024

(30) Foreign Application Priority Data
Dec. 10, 2021 (FR) 2113335

(51) Int. Cl. G07C 9/27

(52) U.S. Cl. CPC G07C 9/27

(57) ABSTRACT

A field of systems and methods for controlling access to an area of a site by a user. Also, a method for initialising said access control method. It has a particularly advantageous application in securing access to an area of a site by a user, potentially in a fully automatic manner, including when the mobile communication device of the user is in offline mode and each access controller has no communication means other than those necessary for a short-range communication with the mobile communication device.

### TECHNICAL FIELD

The present invention relates to the field of systems and methods for controlling access to an area of a site by a user. It also relates to the method for initialising the considered access control method. The invention is particularly advantageous for securing access to an area of a site by a user, potentially in a fully automatic manner, including in an off-line mode.

### PRIOR ART

There are many methods and systems for controlling access to a site. Among the documents describing such methods and systems, mention may for example be made of the patent documents referenced CN 102663815 B and WO 2011/159921 A1.

Known access control methods and systems often require at least one amongst:
an Internet or long-range connection,
an access control unit in communication with access controllers from which it is remote, and
the transmission of personal data of the user, in particular to the access controller.

It is an object of the present invention to provide an access control method and an associated initialisation method which allow overcoming at least one drawback of existing solutions.

Another object of the present invention is to provide an access control method which allows improving securing of access to a site.

More particularly, an object of the present invention is to provide an access control method which does not require, to allow access to a site to be secured:
an Internet or long-range connection, and/or
an access control central unit in communication with access controllers from which it is remote, and/or
the transmission of personal data of the user.

The other objects, features and advantages of the present invention will become apparent upon examining the following description and the appended drawings. It should be understood that other advantages may be incorporated.

### SUMMARY OF THE INVENTION

To achieve this objective, according to an embodiment of a first aspect of the invention, a method for initialising a method for controlling access to an area of a site is provided. The site comprises at least one area and each area being associated with a controller of access to said area. The initialisation method comprises the following steps implemented by a computer server:
a) generating, for each access controller, an encryption private key and an encryption shared key, the encryption private key (PK) and the encryption shared key (SK) preferably forming a symmetric encryption key pair,
b) generating a unique identification number (IDA) of each access controller,
c) storing, in a database of the computer server:
   i. personal data of a user including at least data for establishing a communication (PN), such as a telephone number, with a mobile communication device of the user, and
   ii. a validity end date of the access right, or a validity start date of the access right, and
d) transmitting, to the mobile communication device of the user according to said communication establishment data (PN), a request for installing, on the mobile communication device, an access control application for the implementation of the method for controlling access to an area of a site by a user,
e) said access control application being, once installed on the mobile communication device, configured to generate and store in a storage medium of the mobile communication device, a first random key (MK), receiving, from the mobile communication device, at least the first random key (MK),
f) generating an encryption key (BMK) by encrypting the first random key (MK) with the encryption private key (PK),
g) generating at least one access right (ACCESS) of the user to an area of the site, each access right (ACCESS) comprising at least:
   i. the encryption key (BMK),
   ii. the encryption shared key (SK),
   iii. the unique identification number (IDA) of each access controller associated with an area for which an access right of the user is to be generated, and the validity end date of the access right, or the validity start date of the access right, and
h) transmitting said at least one access right (ACCESS) to the mobile communication device.

It should be noted herein that the storage, in the database of the computer server, of the personal data of the user and the storage of the validity end date of the access right, or of the validity start date of the access right, are not necessarily carried out concomitantly or in a given order. The personal data of the user may be stored once, with possible updates of these data when necessary, whereas the validity end date of the access right, or the validity start date of the access right, may be stored at different times, for example to conduct an authorisation to access an area of a site, without the personal data of the user necessarily having changed.

By implementing the initialisation method as introduced hereinabove, the mobile communication device has been initialised so as to enable the subsequent implementation of an embodiment introduced hereinbelow an access control method according to the second aspect of the invention.

Before introducing the second aspect of the invention, optional features of the first aspect of the invention are set out hereinafter which may possibly be used in combination or separately.

Optionally, the initialisation method as introduced hereinabove may further have at least any one of the following features that may be considered separately or in combination.

According to an example, the initialisation method as introduced hereinabove further comprises the following steps implemented by the computer server:
i) transmitting, to each access controller, the encryption private key (PK) and the encryption shared key (SK) previously generated for said access controller, and
j) transmitting, to each access controller, the identification number (IDA) previously generated for said access controller.

Thus, each access controller has been initialised so as to enable the subsequent implementation of the embodiment introduced hereinbelow of the access control method according to the second aspect of the invention.

According to another example, the initialisation method according to the first aspect of the invention further comprises, following the transmission of said at least one access right (ACCESS) to the mobile communication device, transmitting, by the computer server, to the mobile communication device, data for updating the validity end date of the access right, or the validity start date of the access right.

As already set out hereinabove, the initialisation method according to the previous example allows updating the first initialisation of the mobile communication device, for example, so as to refresh or extend the access right of the user to an area of a site and/or so as to initialise a new access right of the user to another area of the site.

According to another example, the initialisation method according to the first aspect of the invention further comprises the following steps implemented by the computer server:
storing an identifier of the site (SID), and
transmitting, to each access controller, the identifier of the site.

As it will clearly appear when we will introduce the access control method according to the second aspect of the invention, the level of securing of access to an area of a site could thus be advantageously increased.

According to another example, the implementation of steps i) and j) as introduced hereinabove precedes an installation of said at least one access controller on the area of the site associated therewith.

The initialisation of each access controller may be carried out once for all, for example before installation thereof on the site to be secured. Thus, it should be understood that each access controller does not require any long-range communication means. Moreover, the initialisation of each access controller may be carried out manually by a technician of the service provider, without requiring any computer connection means with the computer server. Thus, each access controller may advantageously be free of any communication means other than those necessary for a short-range communication with the mobile communication device. Thus, each access controller may have an advantageously limited cost.

According to another example, the initialisation method according to the first aspect of the invention further comprises the following step implemented by the computer server:
generating an authentication code (PIN) of the mobile communication device, and
transmitting, to the mobile communication device of the user according to said communication establishment data (PN), the authentication code (PIN), the latter being to be entered into said access control application, once the latter is installed on the mobile communication device, to authenticate the mobile communication device.

The initialisation method according to the previous example allows securing the initialisation of the mobile communication device by the computer server. Indeed, according to the previous example, step e) of the initialisation method as introduced hereinabove is implemented after the mobile communication device has been authenticated. More particularly, the authentication code may consist of or comprise a PIN code.

Alternatively or complementarily, the initialisation method according to the previous example may further comprise the following step implemented by the computer server:
transmitting, to the mobile communication device of the user according to said data for establishing a communication (PN), a duration of validity, or equivalently an expiry date, associated with each transmitted authentication code (PIN).

According to another example, each access right (ACCESS) further comprises at least one amongst an identifier of the site (SID) and an identifier of the user (UID).

According to another example, each access right (ACCESS) is free of at least one amongst the encryption private key (PK) of said at least one access controller and the first random key (MK) of the mobile communication device.

As mentioned hereinabove, the second aspect of the invention relates to a method for controlling access to an area of a site by a user. The site comprises at least one area and each area of the site being associated with a controller of access to said area.

The user carries a mobile communication device on which an access control application dedicated to the implementation of the access control method has been installed.

Each access controller stores at least one encryption private key (PK), an encryption shared key (SK) and an identification number (IDA) of the access controller. Preferably, the encryption private key (PK) and the encryption shared key (SK) form a symmetric encryption key pair.

The mobile communication device stores a first random key (MK) previously generated by said access control application and at least one access right (ACCESS) of the user to an area of the site, each access right (ACCESS) comprising at least:
an encryption key (BMK), the encryption key (BMK) having been generated by encrypting the first random key (MK) with the encryption private key (PK),
the encryption shared key (SK),
the identification number (IDA) of the access controller associated with said area, and
a validity end date of the access right, or a validity start date of the access right.

The access control method comprises the following steps:
a) by each access controller of the site, repeatedly emitting its identification number (IDA), according to a telecommunication standard enabling the short-distance bidirectional exchange of data using radiofrequency waves between the access controller and the mobile communication device,
b) by the mobile communication device, receiving an identification number (IDA) emitted by an access controller located at a short range and comparing the received identification number (IDA) with the identification number (IDA) comprised in each access right (ACCESS) stored in the mobile communication device to recognise, in case of a positive comparison, the access controller having emitted the received identification number (IDA) as being associated with an area to which the user has an access right (ACCESS),
c) by the mobile communication device, generating and transmitting, to the recognised access controller, a second random key (K1),
d) by the recognised access controller, receiving the second random key (K1), then generating and transmitting, to the mobile communication device, a third random key (K2),
e) by the mobile communication device, receiving the third random key (K2), then generating and transmitting, to the recognised access controller, an encrypted message (MSG) generated according to at least:
   i. the second random key (K1),
   ii. the third random key (K2),
   iii. the encryption key (BMK) at the area associated with the recognised access controller, i
   iv. the first random key (MK),
   v. the validity end date of the access right, or the validity start date of the access right, and
   vi. the encryption shared key (SK),
f) by the recognised access controller, receiving and decrypting the encrypted message (MSG) using:
   i. the second random key (K1),
   ii. the third random key (K2),
   iii. the encryption key (BMK),
   iv. the encryption shared key (SK) of the recognised access controller, and
   v. the encryption private key (PK), so as to extract therefrom at least the validity end date of the access right, or the validity start date of the access right, and
g) in case of a positive verification of the validity of the access right, this verification depending on the time point at which access is requested relative to the validity end date of the access right, or the validity start date of the access right, issuing, by the recognised access controller, an access authorisation for the user to the area associated with the recognised access controller.

Hence, it appears that the implementation of the access control method according to the second aspect of the invention is based on a short-distance communication between the mobile communication device and the access controller(s) located at a short distance from the mobile communication device. Securing access to the area associated with the recognised access controller is reached even when the mobile communication device is in the off-line mode.

Optionally, the access control method as introduced hereinabove may further have at least any one of the following features which may be considered separately or in combination.

According to one example, the decryption of the encrypted message (MSG) is carried out so as to extract therefrom the random key (MK), then to use the extracted random key (MK) to decrypt a still undecrypted portion of the message (MSG) so as to extract therefrom at least the validity end date of the access right, or the validity start date of the access right. More particularly, the extracted random key (MK) may be used, by the access controller, to generate the encryption key (BMK) by encrypting the first random key (MK) with the encryption private key (PK). Henceforth, the encryption key (BMK) may be used to decrypt the still undecrypted portion of the message (MSG).

According to another example, the implementation of the access control method requires no communication with a computer server, and in particular no communication between a computer server and an access controller.

According to another example, each access right (ACCESS) further comprising at least one amongst an identifier of the site (SID) and an identifier of the user (UID), the generation by the mobile communication device of the encrypted message (MSG) also depends on at least one amongst the identifier of the site (SID) and the identifier of the user (UID), respectively. The decryption of the encrypted message (MSG) may be carried out so as to further extract at least one amongst an identifier of the site (SID) and an identifier of the user (UID).

According to another example, the access control method further comprises, with the access controller further storing the identifier of the site (SID), comparing the identifier of the site (SID) as extracted before with the identifier of the site (SID) stored in the access controller, the access being denied in case of a negative comparison.

According to another example, each of the second random key (K1) and the third random key (K2) has a length equal to or greater than 64 bits.

According to another example, the identifier of the user (UID) as extracted is stored in the access controller, at least if the access is authorised.

According to an example of the first and second aspects of the invention, each of the encryption private key (PK) and/or the encryption shared key (SK) and/or the identification number of each access controller (IDA) and/or the first random key (MK) has a length equal to or greater than 128 bits.

According to another example of the first and second aspects of the invention, the identification number of each access controller has a format determined according to a telecommunication standard enabling the short-range bidirectional data exchange using radiofrequency waves between each access controller and at least one mobile communication device.

According to another example of the first and second aspects of the invention, said at least one access controller is free of any long-range communication device, typically greater than 100 m, preferably greater than 40 m.

According to another example of the first and second aspects of the invention, no personal data is transmitted to said at least one access controller.

According to another example of the first and second aspects of the invention, the encryption private key (PK) of said at least one access controller is not transmitted to the mobile communication device of the user.

The present invention also relates to other aspects including three computer program products. A first one of these three computer program products comprises instructions which, when they are performed by at least one processor of a computer server, executes at least the steps of the initialisation method as introduced hereinabove. A second one of these three computer program products comprises instructions which, when they are performed by at least one processor of an access controller, executes at least steps a), d), f) and g) of the access control method as introduced hereinabove. A third one of these computer program products comprises instructions which, when they are performed by at least one processor of a mobile communication device, executes at least steps b), c) and e) of the access control method as introduced hereinabove.

Another aspect of the present invention relates to an access control system comprising a mobile communication device and at least one access controller, the access control system being configured to implement the access control method as introduced hereinabove.

### BRIEF DESCRIPTION OF THE FIGURES

The aims, objects, as well as the features and advantages of the invention will appear better from the detailed description of an embodiment of the latter which is illustrated by the following appended drawings, wherein:

FIG. 1 shows a flowchart of an embodiment of the initialisation method according to the first aspect of the invention.

FIG. 2 shows a flowchart of an embodiment of the access control method according to the second aspect of the invention.

FIG. 3 schematically shows an embodiment of the access control system according to one of the aspects of the invention.

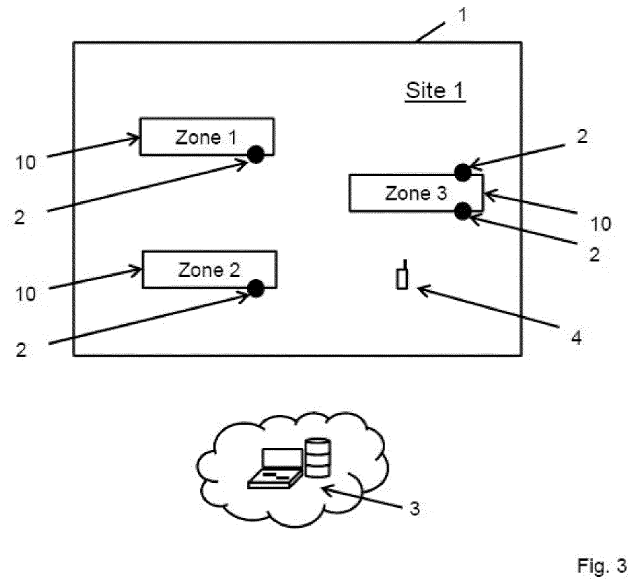

The drawings are given as examples and do not limit the invention. They are intended to facilitate understanding of the invention. In particular, FIG. 3 forms a schematic illustration which is not necessarily plotted to the scale of practical applications.

### DETAILED DESCRIPTION

Embodiments of the different aspects of the invention are described hereinbelow with reference to the appended drawings.

FIG. 3 schematically shows an example of a communication system architecture wherein the methods according to the first and second aspects of the invention are intended to be implemented.

According to the example illustrated in FIG. 3, the matter essentially consists in securing secure access to at least one area 10, amongst the three illustrated areas, of a site 1, by a user equipped with a mobile communication device 4, such as a Smartphone. To this end, and like known access control methods, each area comprises an input, such as a door or a barrier, equipped with an access controller 2. Each area 10 may be equipped with a plurality of access controllers 2; for example, the illustrated third area is equipped with two access controllers. An area 10 may be a room of the site visited by the user, but, alternatively, an area 10 may be a box of a locker.

As this will become apparent upon reading the following description, the controller of access to an area 10 of the site 1 advantageously does not require, according to the present invention, establishing a communication with a remote computer server 3 to process a request for access to an area 10 emitted by a user; the access control method 200 according to the second aspect of the invention can indeed be implemented in an operational manner even when the mobile communication device 4 of the user is in an off-line mode. It should be noted that the representation of the computer server 3 in a cloud first reflects the fact that, during the implementation of the access control method 200 according to the second aspect of the invention, this computer server 3 may be beyond communication range whether with the mobile communication device 4 or with the access controllers 2. Complementarily, the graphical illustration of the computer server 3 in a cloud allows illustrating that the computer server 3 can have access to computer services (other servers, storage, networking, software) via the Internet from a provider; it therefore forms part of a set of hardware, network connections and software providing services that individuals and communities could exploit from anywhere in the world. In this regards, the cloud represents the cloud computing (or “cloud computing” according to the Anglo-Saxon terminology) to which the computer server 3 belongs.

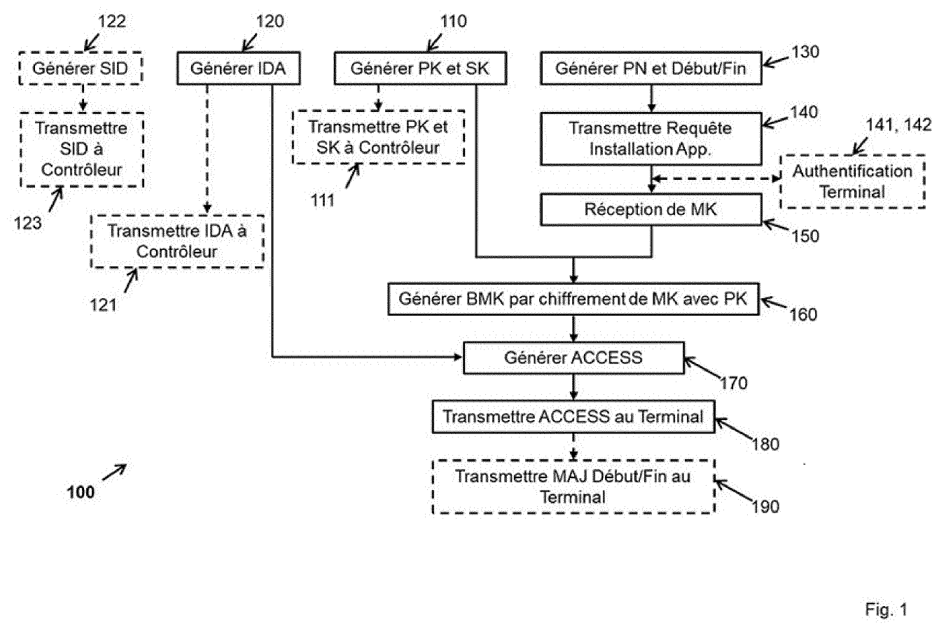

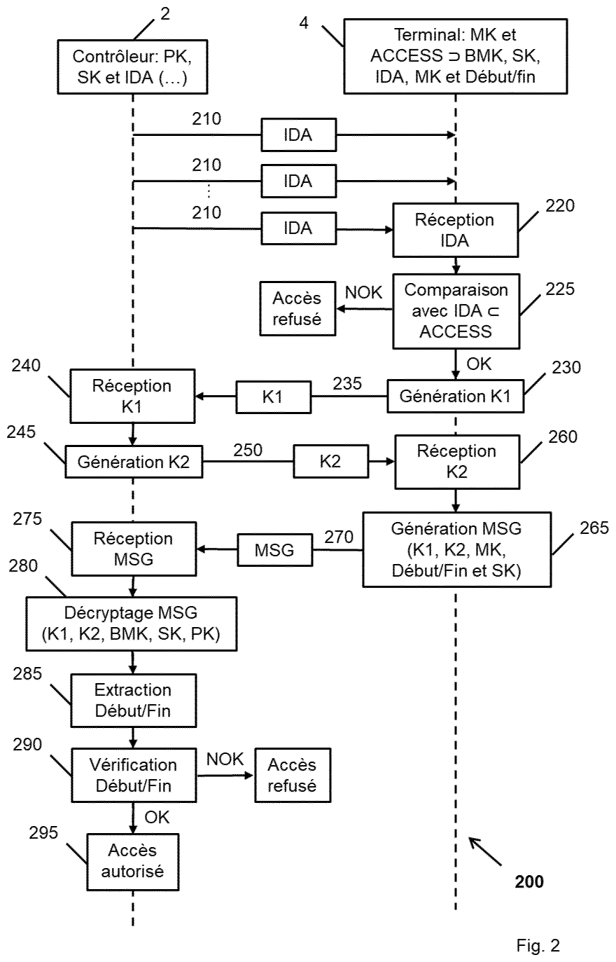

Moreover, it should be noted that in FIGS. 1 and 2, the mobile communication device 4 is so-called “Terminal”. The mobile communication device 4 is able to implement at least:
a telecommunication standard enabling the short-range bidirectional data exchange using radiofrequency waves, such as the standard known by the acronym BLE (standing for “Bluelooth Low Energy” according to the Anglo-Saxon terminology), in particular with each of the access controllers 2, and
a telecommunication standard enabling the bidirectional data exchange, where appropriate at a long range, in particular with the computer server 3.

FIG. 1 shows a flowchart of an embodiment of the initialisation method 100 according to the first aspect of the invention.

The initialisation method 100 according to the embodiment illustrated in FIG. 1 is essentially concerned by the initialisation of the mobile communication device 4 of the user. Optionally, it is also concerned by the initialisation of each access controller 2. To reflect the optional nature of the initialisation of each access controller 2, some of the steps of the initialisation method 100 illustrated in FIG. 1 are framed by long dashed lines.

The initialisation method 100 according to the first aspect of the invention is essentially implemented by the computer server 3 of the service provider for securing access to the areas of the site 1. The different steps of the initialisation method 100 are actually implemented by said computer server 3.

Among these different steps, the generation 110 of an encryption private key (PK) and of an encryption shared key (SK) is therefore carried out by the computer server 3. Preferably, the encryption private key (PK) and the encryption shared key (SK) form a symmetric encryption key pair. For example, the encryption private key (PK) and the encryption shared key (SK) have a length equal to or greater than 128 bits.

It is also found that, among the different steps of the initialisation method 100 implemented by the computer server 3, the generation 120 of a unique identification number (IDA) for each of the access controllers 2 of a site 1.

The initialisation method 100 according to the first aspect of the invention further comprises a step of recording a new user. For the administrator of the computer server 3, this consists herein in retrieving personal data of the user including at least data for establishing a communication (PN) with the mobile communication device 4 and adding a new User type input in the database of the computer server 3. Thus, the recording step results in the storage 130, in a database of the computer server 3, of personal data of the user, including said data for establishing a communication (PN) with the mobile communication device 4, such as a telephone number, and, where appropriate, yet without limitation, other data relating to the user, such as his/her name, his/her billing data, his/her place of residence, the identity of his/her telephone service provider, etc. Preferably, the personal data of the user comprises only said data for establishing a communication (PN) with the mobile communication device 4.

In a manner decorrelated from the step of recording the data relating to the user, the initialisation method 100 according to the first aspect of the invention also comprises storing 130 in the database of the computer server 3 a validity end date of the access right, or a validity start date of the access right (Cf. “Start/End” in FIG. 1); what is essential is that it is possible to subsequently verify whether, at the time point when the user requests access to an area, on the basis of an access right that the computer server 3 would have communicated thereto, said access right is valid or not. For example, the validity end date of the access right, and possibly the validity start date, of the access right, are defined by the administrator of the computer server 3.

As already mentioned hereinabove, the access right(s) that each user has may be updated. This update may be carried out on a periodic basis or following an event, such as a request to renew access right by the user. Similarly, the user data, including in particular the data for establishing a communication (PN), may be updated at any time, for example following a request of the user accordingly.

In general, yet in a non-limiting manner, any communication between the computer server 3 and the mobile communication device 4 of the user, whether this communication relates to the initialisation of the access control method 200 according to the second aspect of the invention or relates to updates, is carried out by implementing at least one long-range communication technique, such as an Internet, satellite or GSM (standing for “Global System for Mobile Communications” according to the Anglo-Saxon terminology) connection. Hence, it is not necessary for the user to move in order to subscribe to the secure access services of his/her supplier; the step of recording and, where appropriate, the different steps of updating may advantageously be carried out from the place where the user is located provided that, at this place, a long-range communication technique, supported by the mobile communication device 4 and the computer server 3, is available.

Still with reference to FIG. 1, the initialisation method 100 according to the first aspect of the invention further comprises transmitting 140, by and from the computer server 3, up to the mobile communication device 4 of the user, a request for installation of a software application dedicated to the implementation of some of the steps of the initialisation method 100 according to the first aspect of the invention and steps of the access control method 200 according to the second aspect of the invention. Where appropriate, the installation of the dedicated software application on the mobile communication device 4 may be preceded by downloading said software application on the mobile communication device 4.

In the context of the implementation of the initialisation method 100 according to the first aspect of the invention, said application, once installed on the mobile communication device 4, is essentially configured so as to generate and store, in a storage medium of the mobile communication device 4, a first random (MK). For example, the first random key (MK) has a length equal to or greater than 128 bits.

The initialisation method 100 according to the first aspect of the invention then comprises a step, carried out by the computer server 3, which consists in receiving 150, from the mobile communication device 4, the first random key (MK) generated by said application. The transmission, from the mobile communication device 4, of the first random key (MK) to the computer server 3 may be managed by said application in a transparent manner for the user.

Nonetheless, prior to the reception 150 by the computer server 3 of the first random key (MK), and possibly prior to the transmission by the mobile communication device 4 of the first random key (MK), the initialisation method 100 according to the first aspect of the invention may, optionally, comprise a step of authenticating the mobile communication device 4. To this end, the initialisation method 100 comprises a step consisting in transmitting 142, from the computer server 3 up to the mobile communication device 4 of the user, and according to said data for establishing a communication (PN), an authentication code (PIN), such as a PIN (standing for “Personal Identification Number” according to the Anglo-Saxon terminology) code or any other type of password. For example, the authentication code (PIN) is to be entered into said access control application, once the latter is installed on the mobile communication device 4. Preferably, the authentication code (PIN) has been generated 141 by the computer server 3 itself, before in the transmission step 142.

For example, said installation request is sent by the computer server 3 to the mobile communication device 4 by an SMAS (standing for “Short Message Service” according to the Anglo-Saxon terminology), comprising, where appropriate, the PIN code. The PIN code may further be associated with a validity limit date. For example, the mobile communication device 4 authenticates before the computer server 3 by returning thereto a message comprising the previously received PIN code. The authentication may be effective only if the PIN code is received by the computer server 3 before its validity limit date. The SMS returned by the mobile communication device 4 to the computer server 3 may also comprise the data for establishing a communication (PN) with the mobile communication device 4, advantageously to automate the step of recording the user relative to a manual input by the administrator of the computer server 3 and/or the first random key (MK).

It should be noted that, at this stage, the computer server 3 and the mobile communication device 4 know the first random key (MK). On the other hand, only the computer server 3 knows the encryption private key (PK); more particularly, the mobile communication device 4 does not know the encryption private key (PK), and this will remain so.

Once the first random key (MK) has been received 150 by the computer server 3, the initialisation method 100 comprises a step consisting in generating 160 an encryption key (BMK) by encrypting the first random key (MK) with the encryption private key (PK). Henceforth, by a conventional symmetric encryption scheme, it is possible to decrypt the encryption key (BMK) using the encryption private key (PK). For example, the encryption key (BMK) has a bit length equal to that of the first random key (MK).

Once the encryption key (BMK) has been generated 160, the initialisation method 100 comprises a step consisting in generating 170 at least one access right (ACCESS) of the user to an area of the site, each access right (ACCESS) comprising at least:
the encryption key (BMK),
the encryption shared key (SK),
the unique identification number (IDA) of each access controller 2 associated with an area 10 for which an access right (ACCESS) of the user is to be generated, and
the validity end date of the access right, or the validity start date of the access right.

Each access right (ACCESS) may further comprise at least one amongst an identifier of the site (SID) and an identifier of the user (UID). Preferably, the format of the identifier of the user (UID) is predefined by the telecommunication standard, for example the standard associated with the aforementioned BLE technique, used to enable the mobile communication device 4 and each access controller 2 to exchange data with each other.

It should be noted that each access right (ACCESS) is free of the encryption private key (PK). Furthermore, each access right (ACCESS) may advantageously be free of the first random key (MK) associated with the mobile communication device 4.

Once generated 170, the access right(s) (ACCESS) are transmitted 180 to the mobile communication device 4. Following reception of the access right(s) (ACCESS) by the mobile communication device 4, the aforementioned application stores them in the storage medium of the mobile communication device 4, preferably in secure mode.

As already mentioned hereinabove, following the transmission 180 of the access right(s) (ACCESS) to the mobile communication device 4, the initialisation method 100 may comprise a step consisting in transmitting 190, from the computer server 3 to the mobile communication device 4, data for updating the validity end date of the access right, or the validity start date of the access right.

As already introduced hereinabove, the initialisation method 100 also optionally comprises initialising the different access controllers 2. This initialisation involves the steps which, in FIG. 1, are illustrated by lines and long dashed line frames.

This initialisation comprises at least transmitting 111 the encryption private key (PK) and the encryption shared key (SK) to each access controller 2 and transmitting 121 to each access controller 2, the identification number (IDA) previously generated 120 for said access controller 2.

Complementarily, the initialisation of the different access controllers 2 may comprise transmitting 123 to each access controller 2 an identifier (SID) of the site 1 on which the access controller 2 is installed or is preferably intended to be installed. It should be noted herein that the identifier of the site (SID) may also be transmitted to the mobile communication device 4, for example by being included in each of the generated access rights 170. It should also be noted that the identifier of the site (SID) could have been defined and entered by the administrator of the computer server 3.

Hence, the initialisation of the different access controllers 2 essentially consists in transmitting a certain number of information to said access controller 2, so that they know them and retain them, in particular by storing them in a storage medium. More particularly, said information are preferably integrated directly into the embedded software (or “firmware” according to the Anglo-Saxon terminology) of each controller 2. The transmission of said information to each access controller 2 may be carried out by a technician of the service provider, either manually or, via the computer server 3, using, for example, a communication technology complying with a telecommunication standard enabling the short-range data exchange, at least unidirectional (from the computer server 3 towards the access controller 2), using radiofrequency waves.

The initialisation of each access controller 2 does not a priori require updating; it may be carried out once for all, for example in a premises of the access service provider, and therefore before installation thereof on the site 1 to be secured. Thus, it should be understood that each access controller 2 does not require long-range communication means, such as an Internet connection or a long-range radiofrequency connection (GPS, GSM, etc.), capable of enabling a communication over a distance typically longer than 100 m, or longer than 40 m. Thus, each access controller 2 may advantageously be free of any communication means other than those necessary for a short-range communication with the mobile communication device 4, this short-range communication being detailed hereinbelow. It arises from the foregoing that each access controller 2 could thus have an advantageously limited cost.

By implementing the initialisation method 100 as introduced hereinabove, the mobile communication device and, optionally, each access controller 2, have been initialised so as to enable the subsequent implementation of an embodiment detailed hereinbelow of the access control method 200 according to the second aspect of the invention.

An embodiment of the method for controlling access 200 to an area of a site by a user according to the second aspect of the invention is described hereinbelow with reference to FIG. 2.

As already detailed hereinabove, the site 1 comprises at least one area 10 and each area 10 of the site 1 is associated with a controller of access 2 to said area 10.

The user carries a mobile communication device 4 on which an access control application dedicated to the implementation of the access control method 200 has been installed.

Each access controller 2 stores at least one encryption private key (PK), an encryption shared key (SK) and an identification number (IDA) of the access controller 2. Preferably, the encryption private key (PK) and the encryption shared key (SK) form a symmetric encryption key pair.

In turn, the mobile communication device 4 stores a first random key (MK) previously generated by said access control application and at least one access right (ACCESS) of the user to an area 10 of the site 1.

Each access right (ACCESS) comprises at least:
an encryption key (BMK), the encryption key (BMK) having been generated by encrypting the first random key (MK) with the encryption private key (PK),
the encryption shared key (SK),
the identification number (IDA) of the access controller 2 associated with said area 10, and
a validity end date of the access right, or a validity start date of the access right (Cf. “Start/End” in FIG. 2).

The access control method 200 as illustrated in FIG. 2 comprises the following steps.

By each access controller of the site, the repeated transmission 210 of its identification number (IDA), according to a telecommunication standard enabling the short-distance bidirectional data exchange using radiofrequency waves between the access controller 2 and the mobile communication device 4, for example the standard associated with the technique known under the acronym BLE.

By the mobile communication device, the reception 220 of an identification number (IDA) emitted by an access controller 2 located at a short distance and the comparison 225 of the received identification number (IDA) with the identification number (IDA) included in each access right (ACCESS) stored in the mobile communication device 4. In order to receive 220 the identification numbers (IDA) emitted by each access controller 2 located at a short distance from the mobile communication device 4, it may be necessary for the application dedicated to the implementation of the access control method 200 according to the second aspect of the invention to be in standby or launched by the user via the interface of his/her mobile communication device 4. Thus, it should be understood that, when said application is not running, the user can pass in the proximity of any area 10 of the site 1 without his/her access rights being able to be compromised or hacked. In this manner, the mobile communication device 4 may recognise, in case of a positive comparison, the access controller 2 having emitted the received identification number (IDA) as being associated with an area 10 to which the user has a right access (ACCESS). In case of a negative comparison, access is denied. Thus, the comparison 225 contributes to an increase in the level of security of the access.

By the mobile communication device 4, the generation 230 and the transmission 235, to the recognised access controller 2, of a second random key (K1).

By the recognised access controller 2, the reception 240 of the second random key (K1), then the generation 245 and the transmission 250, to the mobile communication device 4, of a third random key (K2).

Each one amongst the second random key (K1) and the third random key (K2) has a length equal to or greater than 64 bits. Preferably, the second random key (K1) and the third random key (K2) are in a known predetermined format of each access controller 2 and of the mobile communication device 4.

These random key exchanges (K1 and K2) form some kind of a challenge between the recognised access controller 2 and the mobile communication device 4 which allows justifying a first level of securing access to said area 10.

By the mobile communication device 4, the reception 260 of the third random key (K2), then the generation 265 and the transmission 270, to the recognised access controller 2, of an encrypted message (MSG). More particularly, the encrypted message (MSG) is encrypted at least according to:
the second random key (K1),
the third random key (K2),
the encryption key (BMK) at the area 10 associated with the recognised access controller 2,
the first random key (MK),
the validity end date of the access right, or the validity start date of the access right, and
the encryption shared key (SK).

More particularly, the encryption of the message (MSG) may involve a first encryption of the first random key (MK) and a second encryption of the validity end date of the access right, or the validity start date of the access right, where appropriate, together with other data, selected in particular from among those relating to the user.

By the recognised access controller 2, the reception 275 and the decryption 280 of the encrypted message (MSG) using:
the second random key (K1),
the third random key (K2),
the encryption key (BMK),
the encryption shared key (SK) of the recognised access controller 2, and
the encryption private key (PK).

More particularly, the decryption 280 of the encrypted message (MSG) is carried out so as to extract therefrom at least the validity end date of the access right, or the validity start date of the access right. Where appropriate, the encryption key (BMK) may be generated by the access controller, before being used for the decryption 280 of the encrypted message (MSG), and more particularly for the decryption 280 of a still undecrypted portion of the message (MSG); we return to this point hereinbelow.

In case of a positive verification of the validity of the access right, this verification 290 depending on the time point at which the access is requested relative to the validity end date of the access right, or to the validity start date of the access right, the access control method 200 comprises issuing 295, by the recognised access controller 2, an authorisation for the user to access the area 10 associated with the recognised access controller 2.

Thus, it clearly appears that the implementation of the access control method 200 according to the second aspect of the invention is potentially, and preferably, based only on a short-range communication between the mobile communication device 4 and the access controller(s) 2 located at a short distance from the mobile communication device 4. In particular, the implementation of the access control method 200 according to the second aspect of the invention does not require any communication of the mobile communication device 4 and/or of any one of the access controllers 2 with an access control unit, such as the computer server 3, whether the latter is remote or not. Securing access to the area 10 associated with the recognised access controller 2 is potentially carried out in fully automatic manner, but above all it is reached even when the mobile communication device 4 is in the off-line mode, this mode herein defining the situation in which the mobile communication device 4 is unable to communicate using the long-range communication technologies that it supports. It should be noted herein that the mobile communication device 4 is in an off-line mode as soon as the mobile communication device 4 is in a so-called white area, at least for long-range communication technologies that it supports. Moreover, the mobile communication device 4 may be set in an off-line mode by the user himself/herself. Such an off-line setting of the mobile communication device 4 may be required under certain circumstances, for example on a sensitive site, in particular a Seveso classified site, or on-board an aircraft. Furthermore, and we will return thereto hereinbelow, no use of a remote user database is required to implement the access control method 200 according to the second aspect of the invention.

The decryption of the encrypted message (MSG) may be carried out so as to also extract the random key (MK) therefrom. The decryption of the encrypted message (MSG) may be carried out so as to further extract the encryption private key (PK). In this manner, the extracted random key (MK) may be used to decrypt a still undecrypted portion of the message (MSG). The decryption of the encrypted message (MSG) to extract therefrom at least one amongst the random key (MK) and the encryption private key (PK) may, for example, involve the second random key (K1) and the third random key (K2). More particularly, this second decryption level may then be carried out so as to extract, from the still undecrypted portion of the message (MSG), at least the validity end date of the access right, or the validity start date of the access right. The double encryption of the encrypted message (MSG) participates in increasing the level of security of the access. More particularly, the extracted random key (MK) may be used, by the access controller, to generate the encryption key (BMK) by encrypting the first random key (MK) with the encryption private key (PK). Henceforth, the encryption key (BMK) may be used to decrypt the still undecrypted portion of the message (MSG).

When each access right (ACCESS) further comprises at least one amongst an identifier of the site (SID) and an identifier of the user (UID), the generation 265 by the mobile communication device 4 of the encrypted message (MSG) may further depend on at least one of these parameters. The decryption 280 of the encrypted message (MSG) can then be performed also so as to extract therefrom at least one amongst the identifier of the site (SID) and the identifier of the user (UID).

When the access controller 2 knows the identifier of the site (SID), the access control method 200 may further comprise comparing the identifier of the site (SID) as previously extracted with the identifier of the site (SID) stored in the access controller 2. Access is denied in case of a negative comparison thereby contributing to an increase in the level of security of the access.

The identifier of the user (UID) as extracted may be stored in the access controller 2, at least if access is authorised. Alternatively, a trace of the access to the area 10 may be stored in the mobile communication device 4 which could automatically transfer, for example via the application, the corresponding data to the computer server 3, for example when the mobile communication device 4 will be located at a place where it will be again capable of communicating with the computer server 3. In this manner, a tracking of the different visits of the different areas by the different users may be ensured at the computer server 3.

It should be noted that no personal data of the user is transmitted to any access controller 2, neither during the implementation of the initialisation method 100 according to the first aspect of the invention, nor during the implementation of the access control method 200 according to the second aspect of the invention. The only equipment involved in these methods that should know the personal data of the user are the mobile communication device of said user and the computer server 3. Thus, the risk of leakage or piracy of the personal data of the user is advantageously overcome.

The invention is not limited to the previously-described embodiments and extends to all embodiments covered by the claims.

1. A method for initialising a method for controlling access to an area of a site, the site comprising at least one area and each area being associated with a controller of access to said area, the initialisation method comprising the following steps implemented by a computer server:
a) generating, for each access controller, an encryption private key (PK) and an encryption shared key (SK),
b) generating a unique identification number (IDA) of each access controller,
c) storing, in a database of the computer server, personal data of a user including at least data for establishing a communication (PN), with a mobile communication device of the user and a validity end date of the access right,
d) transmitting, to the mobile communication device of the user according to said communication establishment data (PN), a request for installing, on the mobile communication device, an access control application for the implementation of the method for controlling access to an area of a site by a user,
e) said access control application being, once installed on the mobile communication device, configured to generate and store in a storage medium of the mobile communication device, a first random key (MK), receiving, from the mobile communication device, at least the first random key (MK),
f) generating an encryption key (BMK) by encrypting the first random key (MK) with the encryption private key (PK),
g) generating at least one access right (ACCESS) of the user to an area of the site, each access right (ACCESS) comprising at least:
i. the encryption key (BMK),
ii. the encryption shared key (SK),
iii. the unique identification number (IDA) of each access controller associated with an area for which an access right of the user is to be generated, and
iv. the validity end date of the access right,
h) transmitting said at least one access right (ACCESS) to the mobile communication device,
i) transmitting, to each access controller, the encryption private key (PK) and the encryption shared key previously generated for said access controller, and
j) transmitting, to each access controller, the identification number (IDA) previously generated for said access controller.

2. The initialisation method according to claim 1, further comprising, following the transmission of said at least one access right (ACCESS) to the mobile communication device, transmitting, by the computer server to the mobile communication device, data for updating the validity end date of the access right.

3. The initialisation method according to claim 1, further comprising the following steps implemented by the computer server:
storing an identifier of the site (SID), and
transmitting, to each access controller, the identifier of the site (SID).

4. The initialisation method according to claim 1, further comprising the following step implemented by the computer server:
generating an authentication code (PIN) of the mobile communication device, and
transmitting, to the mobile communication device of the user according to said communication establishment data (PN), the authentication code (PIN), the latter being to be entered into said access control application, once the latter is installed on the mobile communication device, to authenticate the mobile communication device.

5. The initialisation method according to claim 4, wherein step e) is implemented after the mobile communication device has been authenticated.

6. The initialisation method according to claim 1, wherein each access right (ACCESS) further comprises at least one amongst an identifier of the site (SID) and an identifier of the user (UID).

7. A method for controlling access to an area of a site by a user, the site comprising at least one area and each area of the site being associated with a controller of access to said area,
the user carrying a mobile communication device on which an access control application dedicated to the implementation of the access control method has been installed,
each access controller storing at least one encryption private key (PK), an encryption shared key (SK) and an identification number (IDA) of the access controller, the mobile communication device storing a first random key (MK) previously generated by said access control application and at least one access right (ACCESS) of the user to an area of the site, each access right (ACCESS) comprising at least:
i. an encryption key (BMK), the encryption key (BMK) having been generated by encrypting the first random key (MK) with the encryption private key (PK),
ii. the encryption shared key (SK),
iii. the identification number (IDA) of the access controller associated with said area, and
iv. a validity end date of the access right,
the access control method comprising the following steps:
a) by each access controller of the site, repeatedly emitting its identification number (IDA), according to a telecommunication standard enabling the short-distance bidirectional exchange of data using radiofrequency waves between the access controller and the mobile communication device,
b) by the mobile communication device, receiving an identification number (IDA) emitted by an access controller located at a short range and comparing the received identification number (IDA) with the identification number (IDA) comprised in each access right (ACCESS) stored in the mobile communication device to recognise, in case of a positive comparison, the access controller having emitted the received identification number (IDA) as being associated with an area to which the user has an access right (ACCESS),
c) by the mobile communication device, generating and transmitting, to the recognised access controller, a second random key (K1),
d) by the recognised access controller, receiving the second random key (K1), then generating and transmitting, to the mobile communication device, a third random key (K2),
e) by the mobile communication device, receiving the third random key (K2), then generating and transmitting, to the recognised access controller, an encrypted message (MSG) generated according to at least:
i. the second random key (K1),
ii. the third random key (K2),
iii. the encryption key (BMK) at the area associated with the recognised access controller,
iv. the first random key (MK),
v. the validity end date of the access right, and
vi. the encryption shared key (SK),
f) by the recognised access controller, receiving and decrypting the encrypted message (MSG) using:
i. the second random key (K1),
ii. the third random key (K2),
iii. the encryption key (BMK),
iv. the encryption shared key (SK) of the recognised access controller, and
v. the encryption private key (PK), so as to extract therefrom at least the validity end date of the access right, and
g) in case of a positive verification of the validity of the access right, this verification depending on the time point at which access is requested relative to the validity end date of the access right, issuing, by the recognised access controller, an access authorisation for the user to the area associated with the recognised access controller.

8. The access control method according to claim 7, wherein decrypting the encrypted message (MSG) is carried out so as to extract therefrom the random key (MK), then using the extracted random key (MK) to decrypt a still undecrypted portion of the message (MSG) so as to extract therefrom at least the validity end date of the access right.

9. The access control method according to claim 7, wherein, each access right (ACCESS) further comprising at least one amongst an identifier of the site (SID) and an identifier of the user (UID), generating by the mobile communication device the encrypted message (MSG) is further based on at least one amongst the identifier of the site (SID) and the identifier of the user (UID), respectively.

10. The access control method according to claim 2, wherein decrypting the encrypted message (MSG) is carried out so as to further extract at least one amongst an identifier of the site (SID) and an identifier of the user (UID).

11. The access control method according to claim 10, further comprising, with the access controller further storing the identifier of the site (SID), comparing the identifier of the site (SID) as previously extracted with the identifier of the site (SID) stored in the access controller, access being denied in case of a negative comparison.

12. A computer program product comprising instructions, which when they are performed by at least one processor of a computer server, executes at least the steps of the initialisation method according to claim 1.

13. The A computer program product comprising instructions, which when they are performed by at least one processor of an access controller, executes at least steps a), d), f) and g) of the access control method according to claim 7.

14. The A computer program product comprising instructions, which when they are performed by at least one processor of a mobile communication device, executes at least steps b), c) and e) of the access control method according to claim 7.
